(19) United States
(12) Patent Application Publication
(10) Pub. No.: US 2015/0023152 A1
(43) Pub. Date: Jan. 22, 2015

(54) METHOD FOR CHANGING TERMINAL ACCOMMODATION DESTINATION, SERVER APPARATUS AND TERMINAL APPARATUS

(71) Applicant: Kabushiki Kaisha Toshiba, Tokyo (JP)

(72) Inventor: Hideaki Nakai, Hino-shi (JP)

(73) Assignee: Kabushiki Kaisha Toshiba, Tokyo (JP)

(21) Appl. No.: 14/246,998

(22) Filed: Apr. 7, 2014

Related U.S. Application Data
(60) Provisional application No. 61/857,162, filed on Jul. 22, 2013.

(51) Int. Cl. H04L 12/24

(52) U.S. Cl. CPC H04L 41/0668
USPC 370/219

(57) ABSTRACT

According to one embodiment, there is provided a method of changing a terminal accommodation destination, which is used in a server apparatus including a plurality of resources and connected to a plurality of exchanges via a communication network, the plurality of exchanges performing an exchange service associated with a call connection among a plurality of communication terminals. In the method, a failure of at least one of the plurality of exchanges is detected and, when a failed exchange is detected, an accommodation destination of a communication terminal accommodated in the failed exchange is changed to the server apparatus in accordance with a usage state of the plurality of resources.

### CROSS-REFERENCE TO RELATED APPLICATIONS

This application claims the benefit of U.S. Provisional Application No. 61/857,162, filed Jul. 22, 2013, the entire contents of which are incorporated herein by reference.

### FIELD

Embodiments described herein relate generally to a method for changing a terminal accommodation destination, a server apparatus and a terminal apparatus, which are employed in an Internet Protocol (IP) telephone system, for example.

### BACKGROUND

Recently, an Internet Protocol (IP) telephone system has become widespread. The IP telephone system receives and transmits packet data which is included images and voice in real time bidirectionally via an IP network such as a local area network (LAN) and the Internet. In the IP telephone system, a plurality of IP telephone servers are connected to the IP network such that each of the IP telephone servers can accommodate an IP telephone terminal. In the IP telephone system, not only extension-to-extension communications and calls to/from outside lines can be performed, but also extension communications between IP telephone servers and communications between outside lines and IP telephone servers can be performed via the IP network.

In the above IP telephone system, however, a secondary IP telephone server has to be placed as a backup of an IP telephone terminal for each node in case an IP telephone server should fail. The placement of the secondary IP telephone server becomes a great burden on a user.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a schematic view showing a configuration of a communication system according to a first embodiment of the present invention;

FIG. 2 is an illustration specifically showing a configuration of a virtualized machine server in the first embodiment of the present invention;

FIG. 3 is a block diagram showing a functional configuration of an IP exchange and an IP telephone terminal in the first embodiment of the present invention;

FIGS. 4A, 4B and 4C are a table for managing a setting state of an option service function associated with an exchange process between IP telephone terminals in the first embodiment of the present invention;

FIG. 5 is a block diagram showing a functional configuration of a failure monitoring server and a portal server of a data center in the first embodiment of the present invention;

FIG. 6 is an example of a table of contents stored in a storage for backup data which is updated/referred to by a data backup control unit of the failure monitoring server of the data center in the first embodiment of the present invention;

FIG. 7 is an example of a virtual machine management table that stores data which is updated/referred to by a virtual machine control unit of the failure monitoring server of the data center in the first embodiment of the present invention;

FIG. 8 is an example of an IP telephone management table that stores data which is updated/referred to by an IP telephone control unit of the portal server of the data center in the first embodiment of the present invention;

FIG. 9 is a chart showing an example of a sequence for registering a serial number in a cloud-based portal server from an IP telephone terminal when a user of the IP exchange uses backup service provided by cloud computing in the first embodiment of the present invention;

FIG. 10 is a chart showing an example of a sequence for regularly backing up call control information data of the IP exchange from a cloud-based failure monitoring server when the user of the IP exchange uses the backup service provided by the cloud computing in the first embodiment of the present invention;

FIG. 11 is a chart showing an example of a sequence for detecting a failure of a backup-targeted IP exchange by the cloud-based failure monitoring server in the first embodiment of the present invention;

FIG. 12 is a chart showing an example of a sequence for failovering the cloud computing by detecting a disconnection of communication between an IP telephone terminal and an IP exchange that has failed in the first embodiment of the present invention;

FIG. 13 is a chart showing an example of a sequence for detecting a recovery in failure of a backup-targeted IP exchange by a cloud-based failure monitoring server in a second embodiment of the present invention; and

FIG. 14 is a chart showing an example of a sequence for failbacking to an IP telephone terminal in a disconnect state of communication with an IP exchange from cloud computing to the IP exchange by detecting a recovery in failure of communication with the IP exchange in the second embodiment of the present invention.

### DETAILED DESCRIPTION

Various embodiments according to the invention will be described hereinafter with reference to the accompanying drawings. In general, according to one embodiment of the invention, a method of changing a terminal accommodation destination, which is used in a server apparatus including a plurality of resources and connected to a plurality of exchanges via a communication network, the plurality of exchanges performing an exchange service associated with a call connection among a plurality of communication terminals, the method comprises, detecting a failure of at least one of the plurality of exchanges, and when a failed exchange is detected, changing an accommodation destination of a communication terminal accommodated in the failed exchange to the server apparatus in accordance with a usage state of the plurality of resources.

### First Embodiment

In the first embodiment, when it is detected that an IP telephone server (referred to as an IP exchange hereinafter) has failed, an accommodation destination of an IP telephone terminal is changed to a cloud virtualized machine server.

Prior to descriptions of the first embodiment, a cloud communication system will be described.

The cloud communication system is a system in which a server for fulfilling a telephone function, a telephone conference function and a web conference function is not provided in a company including a customer or a customer group but assigned to a virtualized machine server that is a cloud server, thereby achieving a telephone function, for example.

The customer is a user unit who contracts with a dealer who mediates between the customer and a telephone service company, for example. The customer group is a unit of combination of a dealer and a customer who contracts with the dealer.

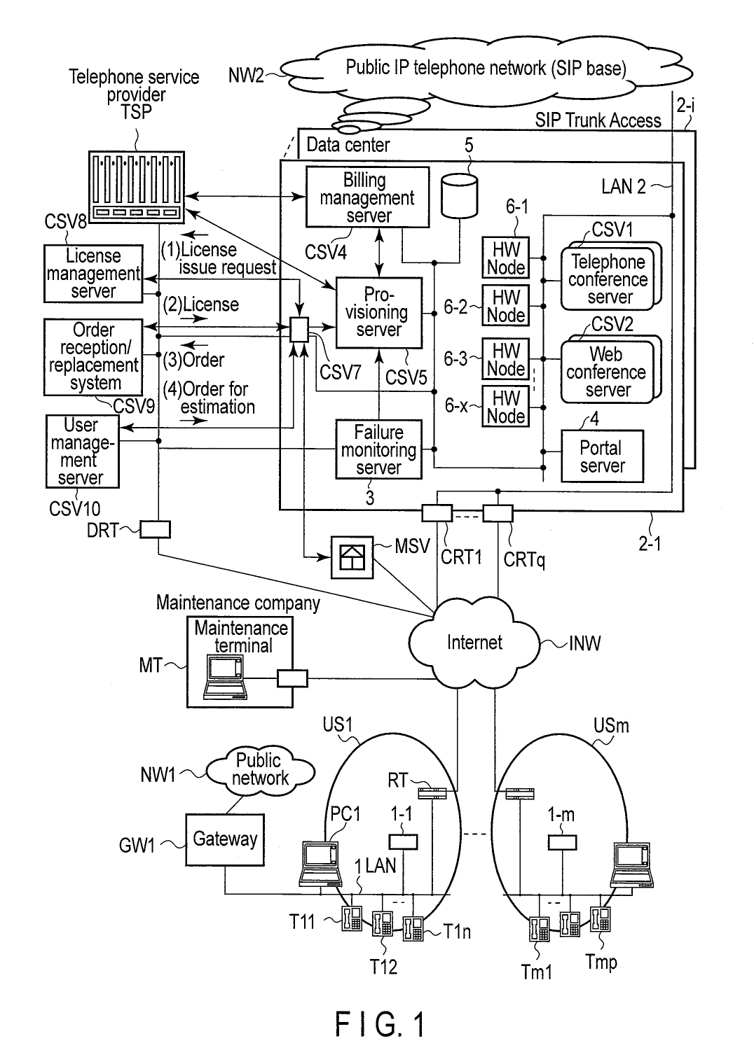

FIG. 1 is a schematic view showing a configuration of a communication system according to the first embodiment of the present invention. In FIG. 1, US1 to USm indicate user sites, 2-1 to 2-i (i is a natural number) indicate data centers on cloud computing and TSP represents a telephone service provider. The data centers 2-1 to 2-i are data centers which provide an information processing server. The telephone service provider TSP provides a customer with a telephone service using computer resources of the data centers 2-1 to 2-i. A maintenance company MT contracts with the telephone service provider TSP, collects customers who use telephone services and mediates between the telephone service provider TSP and the customers such that the customers can receive services from the telephone service provider TSP. The maintenance company MT builds a customer's network, installs an IP telephone and a gateway and makes data setting according to a customer's request.

The telephone service provider TSP and the maintenance company MT who manages users need not be always different companies. It does not matter that they are the same company.

Of the user sites US1 to USm, the user site US1 will be described first as a typical example. The user site US1 includes an IP exchange 1-1, IP telephone terminals T11 to T1n, a personal computer PC1 and a router RT. The IP exchange, IP telephone terminals, personal computer and router are connected to one another via a LAN 1. To the LAN 1, a gateway GW1 is connected. The IP telephone terminals T11 to T1n are telephones having a call processing function and a media (e.g. video) information processing function and can be replaced by softphone in which software for fulfilling a telephone function is installed in a personal computer (PC). The gateway GW1 is provided to connect the LAN 1 with a public network NW1 such as an analog telephone network and has a communication protocol between the LAN 1 and the public network NW1 and a signal format conversion function.

The router RT is connected to the Internet INW and connected to the data centers 2-1 to 2-i via the Internet INW. Of the data centers 2-1 to 2-I, the data center 2-1 will be described as a typical example hereinafter.

The telephone service provider TSP has a function of managing dealers, users, license and reception/placement of orders for IP telephones and network devices. The telephone service provider TSP also has a function of performing maintenance remotely.

The data center 2-1 is a cloud-based data center. The data center 2-1 is connected to an existing public IP telephone network NW2 via a communication network such as the Internet. A call can be made between the data center 2-1 and each of the other data centers 2-2 to 2-i. Furthermore, the data center 2-1 includes virtualized machine servers (hardware nodes (HW Nodes)) 6-1 to 6-x (x is a natural number), a telephone conference server CSV1, a web conference server CSV2, a failure monitoring server 3, an accounting management server CSV4, a provisioning server CSV5, routers CRT1 to CRTq (q is a natural number), a portal server 4 and a backup storage 5, and these are connected to one another via a LAN 2. The routers CRT1 to CRTq are connected to the Internet INW and also connected to the user sites US1 to USm via the Internet INW. The virtualized machine servers 6-1 to 6-x, telephone conference server CSV1, web conference server CSV2, failure monitoring server 3, portal server 4, accounting management server CSV4 and provisioning server CSV5 need not be physically independent of one another. Physically, some of the functions of these servers can be performed by a single server. Moreover, physically, each of the telephone conference server CSV1, web conference server CSV2, failure monitoring server 3, portal server 4, accounting management server CSV4 and provisioning server CSV5 can be configured by a plurality of servers because they are applied as virtualized resources.

If an appliance type IP telephone server is virtualized and operated as it is, computer resources (amounts of usage of a CPU, a memory and a disk) necessary for virtualization are increased and appliance type IP telephone servers are required by the multiple of specifications. Accordingly, only several to ten appliance type IP telephone servers can be operated by a single physical server even though they are virtualized.

In the first embodiment, therefore, the function of a general appliance type IP telephone sever is divided chiefly into a call function, a telephone conference function, a Web conference function and an operation management function. The call function is included in the CP container of each of the virtualized machine servers 6-1 to 6-x. The operation management function is included in the Admin container of each of the virtualized machine servers 6-1 to 6-x. The telephone conference function is included in the telephone conference server provided in the data center separately from the virtualized machine servers 6-1 to 6-x. The Web conference function is also included in the Web conference server provided in the data center separately from the virtualized machine servers 6-1 to 6-x. The telephone conference function and the Web conference function achieve a connection among three or more parties and are separated from a CP container for fulfilling a telephone basic function such as an outgoing call and an incoming call and used as a resource common to a plurality of CP containers, thereby increasing in their diversion efficiency.

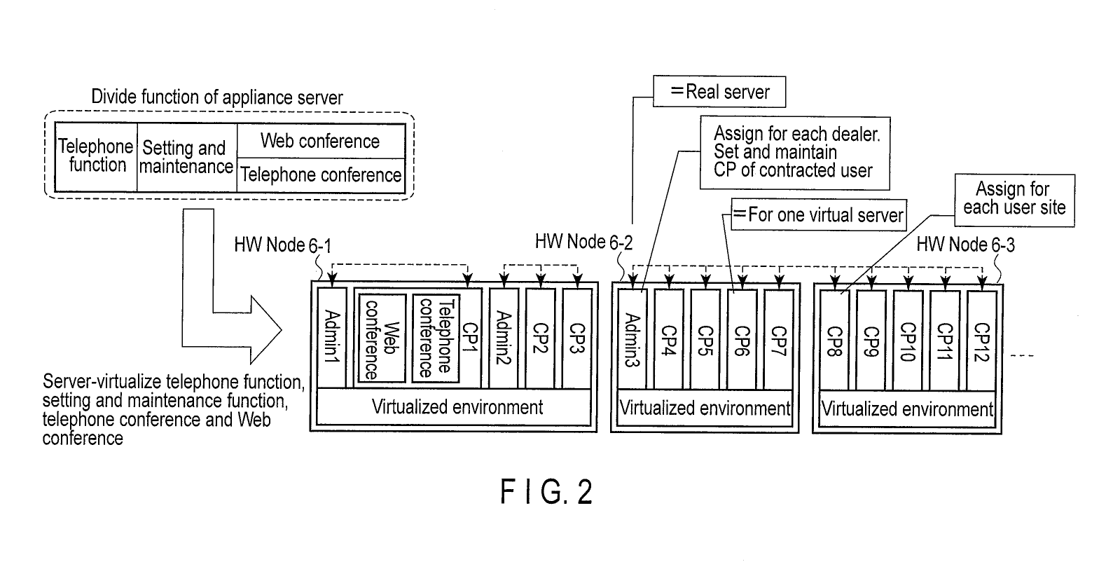

FIG. 2 is an illustration specifically showing a configuration of the above virtualized machine servers 6-1 to 6-x.

The virtualized machine servers 6-1 to 6-x for achieving, as a basic function, a call function of an exchange connection between IP telephone terminals T11 to T1n of the user site US1 who contracts with the virtualized machine servers 6-1 to 6-x and between the IP telephone terminals T11 to T1n and the subscriber lines of the public network NW1.

The virtualized machine servers 6-1 to 6-x, telephone conference server CSV1 and Web conference server CSV2 are achieved in the cloud-based data center 2-1 by dividing the function of a general appliance type IP telephone sever placed on each of the user sites US1 to USm.

In the virtualized machine server 6-1, a virtualized environment is built such that a plurality of virtual servers can be operated. Each of the virtual servers includes one or more Admin containers and CP containers in accordance with its function and capacity.

The CP containers have a call function that is a basic telephone function, a voice mail function, an urgent call function and the like. These functions can easily managed if a connection setting function for connecting terminals for one conventional appliance type IP telephone server is contained in a single CP container, though it depends upon the capacity and operating method of resources provided by the virtual servers.

As described above, the operation management function is included in the Admin container of each of the virtualized machine servers 6-1 to 6-x. The Admin container has a maintenance and management function for setting a CP container, managing license, setting a telephone conference and a Web conference, and the like. In the Admin container, the maintenance and management functions of the conventional appliance type IP telephone servers are integrated and contained. One container is able to maintain and manage a plurality of CP containers, namely, the user sites US1 to USm.

The telephone conference server CSV1 has a function of making a conference connection by voice among the IP telephone terminals T11 to T1n of the user site US1 which contracts with the telephone conference server CSV1. The telephone conference server CSV1 also has a telephone conference function and serves as a common resource server which provides the CP containers with a conference resource.

The Web conference server CSV2 has a function of making a conference connection using media such as video among the IP telephone terminals T11 to T1n of the user site US1 which contracts with the Web conference server CSV2. The Web conference server CSV2 has a Web conference function and serves as a common resource server which provides the CP containers with a conference resource.

Returning to FIG. 1, the failure monitoring server 3 has a function of automatically monitoring virtualized machine servers 6-1 to 6-x, telephone conference server CSV1 and Web conference server CSV2, detecting a failure thereof, maintaining them, raising an alarm, bulk-logging, backing up bulk data, updating a program, updating firmware of an IP telephone terminal, QOS monitoring and the like. The failure monitoring server 3 also has a function of managing inventory information for the automatization in a database.

The accounting management server CSV4 has a function of charging a user based on a measured rate in accordance with an amount of use of the telephone function to acquire user information from the telephone service provider TSP and charge the user.

The provisioning server CSV5 has a function of acquiring information of licenses purchased by the user from the telephone service provider TSP and assigning the resources of the call function, telephone conference function and Web conference function in accordance with the number of purchased licenses. More specifically, the IP telephone terminals (IPT) and IP trunk lines the number of which corresponds to the number of licenses are assigned to the telephone function. In accordance with a user who has acquired a license, it is determined whether the telephone conference function and Web conference function can be used, or it is determined whether the telephone conference server and Web conference server can be used.

The data center 2-1 is provided with a portal server 4. The portal server 4 has an estimating function, an ordering function, an Admin container linking function and an estimation determining function. In the estimating function, when a person of the maintenance company MT inputs information about necessary devices, the number of devices and service in response to a user's request, an estimated charge is calculated. If, in this state, the person of the maintenance company MT depresses a “submit” button, he or she determines the estimated charge and sends email about confirmation of the estimated charge to the user.

In the ordering function, when the person of the maintenance company MT places an order with the telephone service provider TSP (depresses the “submit” button) by the user's determination of the estimated charge, he or she sends a license issuing request to the telephone service provider TSP and also sends an order instruction for an IP telephone, a router, a gateway and the like. Then, the person of the maintenance company MT sends a CP container generating instruction to the provisioning server CSV5 to notify it of the number of extensions, the number of outside lines and the number of conference channels.

The Admin container linking function is a link for opening a maintenance console. The estimation determining function authenticates the estimated charge calculated by the maintenance company MT and sends an estimation confirmation mail to the maintenance company MT when the user depresses the “submit” button.

The maintenance company MT on the Internet INW requests the telephone service provider TSP to place an order for estimation using the portal server 4. The user sites US1 to USm perform estimation and authentication using the portal server 4.

Moreover, a license management server CSV8, an order reception/placement system CSV9 and a user management server CSV10 are connected to the telephone service provider TSP. The server CSV8, system CSV9 and server CSV10 are also connected to the Internet INW via a router DRT.

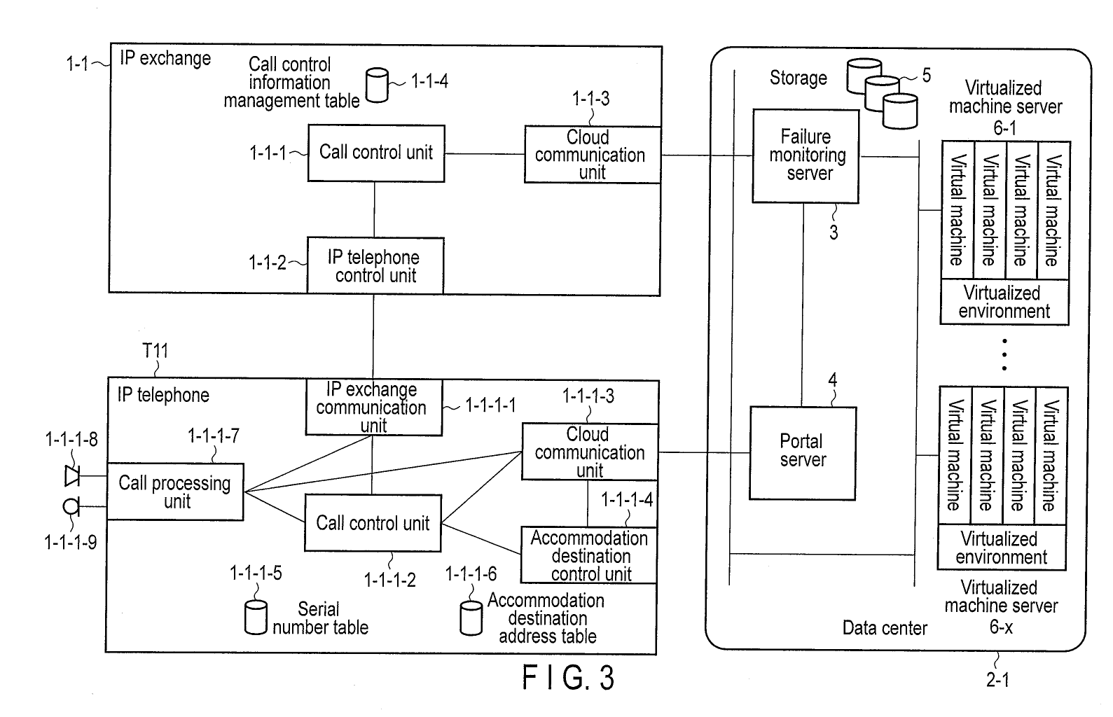

IP exchanges 1-1 to 1-m and IP telephone terminals T11 to Tmp placed on the user sites US1 to USm have the following function as a function according to the first embodiment of the present invention. Hereinafter, the functional configuration of the IP exchange 1-1 and the IP telephone terminal T11 will be described as a typical example of the IP exchanges and that of the IP telephone terminals. FIG. 3 is a block diagram showing the functional configuration.

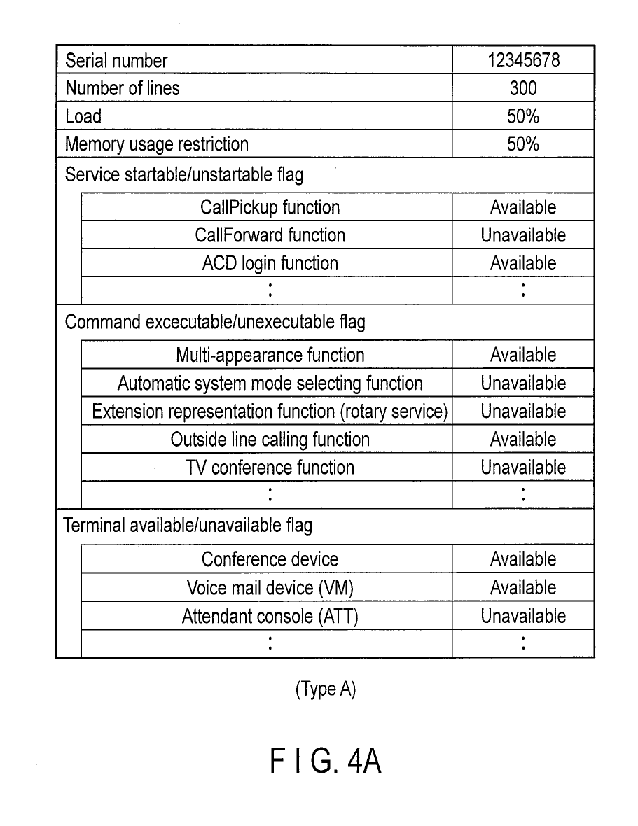

As shown in FIG. 3, the IP exchange 1-1 includes a call control unit 1-1-1, an IP telephone control unit 1-1-2, a cloud communication unit 1-1-3 and a call control information management table 1-1-4. As shown in FIGS. 4A, 4B and 4C, the call control information management table 1-1-4 is a table for managing a setting state of an option service function associated with an exchange process between IP telephone terminals on the basis of the call control information. As shown in FIGS. 4A, 4B and 4C, the call control information management table 1-1-4 stores a flag corresponding to each of the option service functions and indicating whether its corresponding option service function is available. When a flag is set in “available,” its corresponding function is available. When a flag is set in “unavailable,” its corresponding function is unavailable.

FIG. 4A shows an A type of an option service function in which the memory usage restriction is “50%,” a conference device is “available,” a voice mail device is also “available” and an attendant console is “Unavailable.”

FIG. 4B shows a B type of an option service function in which the memory usage restriction is “25%,” the conference device is “Unavailable,” the voice mail device is “available” and the attendant console is “Unavailable.”

FIG. 4C shows a C type of an option service function in which the memory usage restriction is “75%,” the conference device is “available,” the voice mail device is “available” and the attendant console is also “available.”

The call control unit 1-1-1 performs an exchange function of exchanging between the IP telephone terminals T11 to T1n on the basis of the call control information stored in the call control information management table 1-1-4.

The IP telephone control unit 1-1-2 performs communication with, for example, the IP telephone terminal T11 under the control of the call control unit 1-1-1. The cloud communication unit 1-1-3 performs communication with the failure monitoring server 3 of the cloud-based data center 2-1 under the control of the call control unit 1-1-1.

The IP telephone terminal T11 includes an IP exchange communication unit 1-1-1-1, a call control unit 1-1-1-2, a cloud communication unit 1-1-1-3, an accommodation destination control unit 1-1-1-4, a serial number table 1-1-1-5, an accommodation destination address table 1-1-1-6 and a call processing unit 1-1-1-7.

The IP exchange communication unit 1-1-1-1 communicates with, for example, the IP exchange 1-1, and extracts a call signal and a control signal from, for example, an IP packet transmitted via the LAN 1 and supplies the call signal and the control signal to the call processing unit 1-1-1-7 and the call control unit 1-1-1-2, respectively. Then, the IP exchange communication unit 1-1-1-1 multiplexes the call signal sent from the call processing unit 1-1-1-7 and the control signal sent from the call control unit 1-1-1-2 into a transmitting IP packet and sends it to the LAN 1.

The call processing unit 1-1-1-7 reproduces an analog reception voice signal from the call signal sent from the IP exchange communication unit 1-1-1-1. Then, the call processing unit 1-1-1-7 drives a handset receiver 1-1-1-8 in response to the reproduced reception voice signal to cause a reception voice to be output from the receiver.

The call processing unit 1-1-1-7 is supplied with an analog transmission voice signal from a handset transmitter 1-1-1-9. Then, the call processing unit 1-1-1-7 converts the transmission voice signal into a call signal of a given format and supplies it to the IP exchange communication unit 1-1-1-1 or the cloud communication unit 1-1-1-3.

The call control unit 1-1-1-2 controls each unit of the IP telephone terminal T11 by software processing on the basis of the serial number table 1-1-1-5 and the accommodation destination address table 1-1-1-6.

The cloud communication unit 1-1-1-3 communicates with the portal server 4 of the cloud-based data center 2-1 under the control of the call control unit 1-1-1-2.

When the data center 2-1 notifies the accommodation destination control unit 1-1-1-4 that the IP exchange 1-1 has failed, the accommodation destination control unit 1-1-1-4 communicates with the data center 2-1 to change an accommodation destination to the data center 2-1 and updates accommodation destination information of the accommodation destination address table 1-1-1-6 from “IP exchange 1-1” to “virtualized machine server.” When the data center 2-1 notifies the accommodation destination control unit 1-1-1-4 that the failure of the IP exchange 1-1 has been recovered, the accommodation destination control unit 1-1-1-4 communicates with the data center 2-1 to change the accommodation destination to the IP exchange 1-1 and updates the accommodation destination information of the accommodation destination address table 1-1-1-6 from “virtualized machine server” to “IP exchange 1-1.”

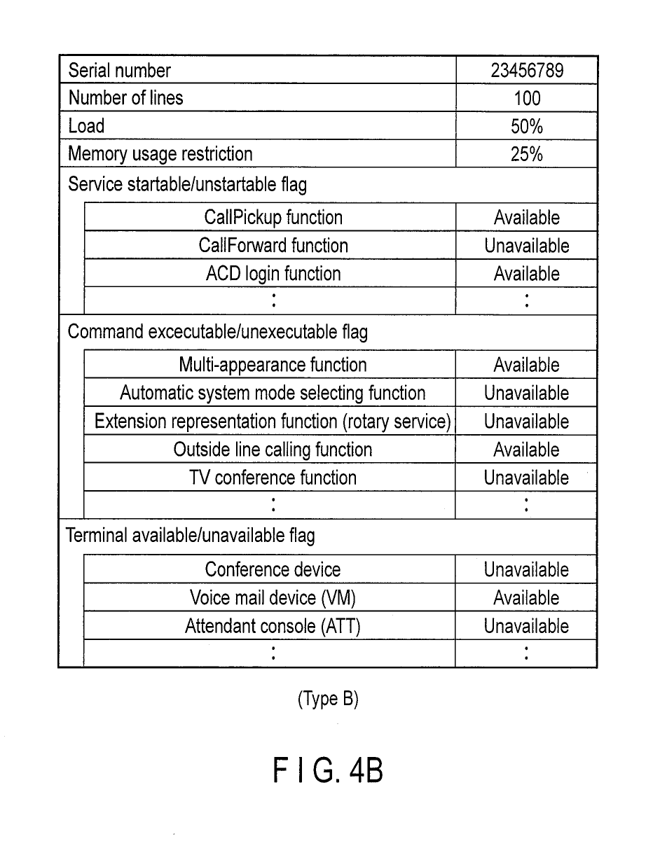

The failure monitoring server 3 and portal server 4 of the data center 2-1 have the following function as a function according to the first embodiment of the present invention. FIG. 5 is a block diagram showing a functional configuration of the failure monitoring server and the portal server.

The failure monitoring server 3 includes a failure monitoring unit 3-1, a data backup control unit 3-2, a virtual machine control unit 3-3, a failure monitoring management table 3-4 and a virtual machine management table 3-5.

The portal server 4 includes an IP telephone control unit 4-1, an accommodation destination acquisition unit 4-2 and an IP telephone management table 4-3.

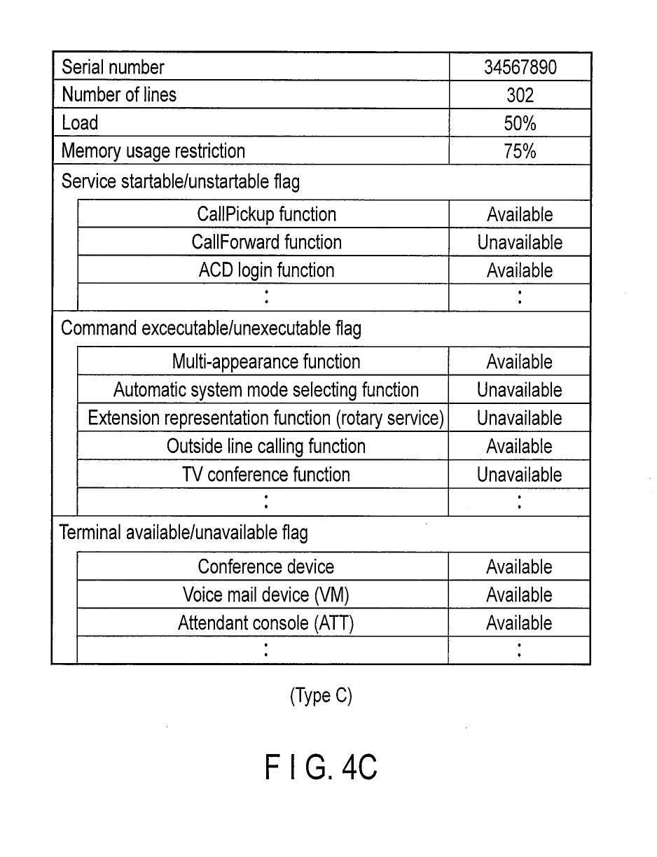

FIG. 6 shows an example of contents stored in the backup storage 5 for backup data, which are updated/referred to by the data backup control unit 3-2 of the failure monitoring server 3 of the data center 2-1. The storage 5 stores serial numbers of IP exchanges and call control information management data in association with each other. Here, the serial number of the IP exchange 1-1 is “12345678” which indicates call control information of type A, and the serial number of the IP exchange 1-2 is “23456789” which indicates call control information of type B. In type B, the number of lines is “100,” the memory usage restriction is “25%” and only the voice mail device is “available.” Furthermore, the serial number of the IP exchange 1-3 is “34567890” which indicates call control information of type C. In type C, the number of lines is “302,” the memory usage restriction is “75%” and all hardware circuits including a conference device, a voice mail device and an attendant console are “available.”

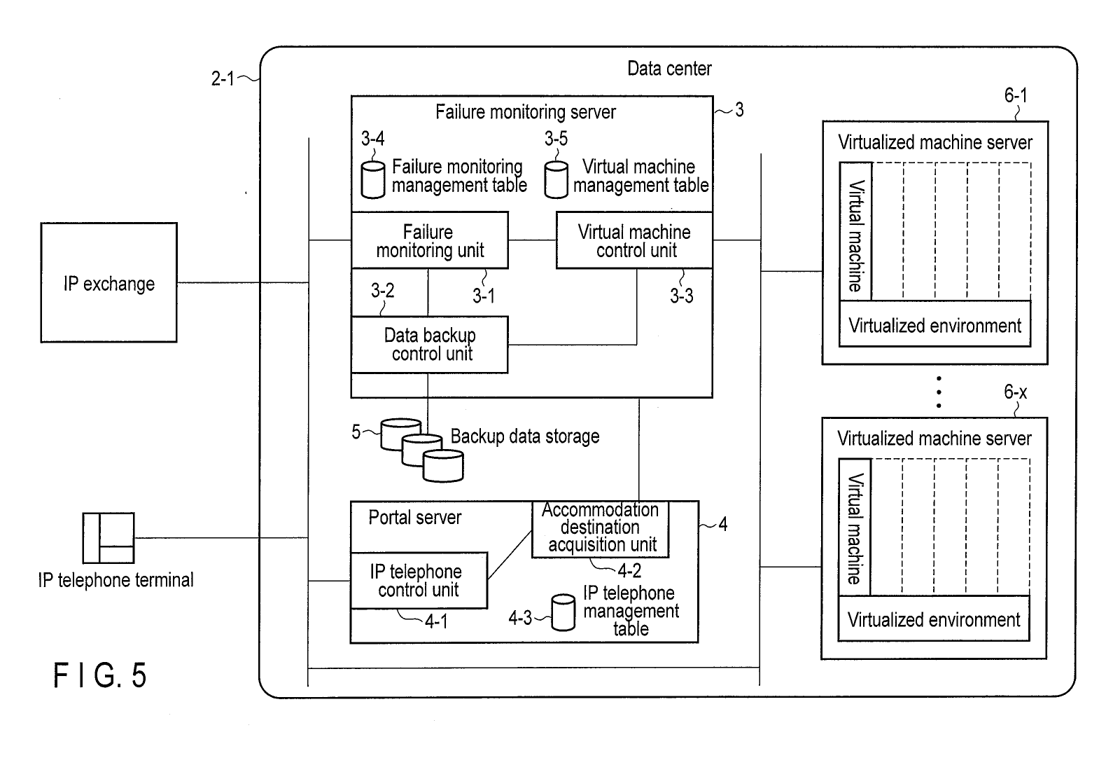

FIG. 7 shows an example of contents stored in the virtual machine management table 3-5, which are updated/referred to by the virtual machine control unit 3-3 of the failure monitoring server 3 of the data center 2-1. The virtual machine management table 3-5 stores serial numbers and IP addresses of virtual machines and serial numbers of IP exchanges in association with each other. When there is no data for the serial number of an IP exchange, it implies that a corresponding virtual machine is virgin.

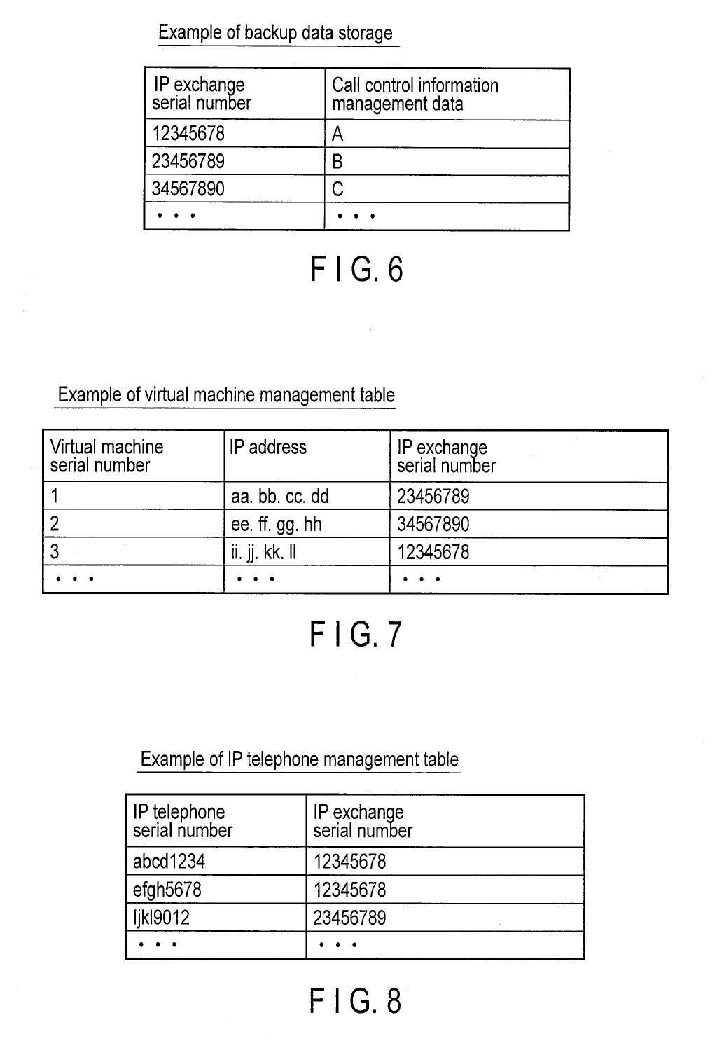

FIG. 8 shows an example of contents stored in the IP telephone management table 4-3, which are updated/referred to by the IP telephone control unit 4-1 of the portal server 4 of the data center 2-1. The IP telephone management table 4-3 stores serial numbers of IP telephone terminals and those of accommodation destination IP exchanges in association with each other.

The failure monitoring unit 3-1 regularly monitors whether the IP exchanges 1-1 to 1-m have failed. If the unit 3-1 detects that an IP exchange has failed, it notifies the virtual machine control unit 3-3 of information of the failed IP exchange.

As a failure monitoring method, under the control of the data backup control unit 3-2, the failure monitoring unit 3-1 regularly transmits a backup request to the IP exchanges 1-1 to 1-m and monitors whether it can receive a response signal from the IP exchanges 1-1 to 1-m in response to the backup request. The failure monitoring unit 3-1 can be configured to monitor whether it can regularly receive a signal from the IP exchanges 1-1 to 1-m.

The data backup control unit 3-2 transmits a backup request to the failure monitoring unit 3-1 on the basis of the backup storage 5.

The virtual machine control unit 3-3 acquires an empty resource in accordance with the usage state of resources of the virtualized machine servers 6-1 to 6-x and change the accommodation destination of an IP telephone terminal accommodated in a failed IP exchange which is notified by the failure monitoring unit 3-1 to the virtualized machine servers 6-1 to 6-x.

The accommodation destination acquisition unit 4-2 acquires information of the virtualized machine servers 6-1 to 6-x which are accommodation destinations notified by the failure monitoring server 3. The IP telephone control unit 4-1 changes the accommodation destination of an IP telephone terminal to a corresponding one of the virtualized machine servers 6-1 to 6-x.

Next, an operation of the above configuration will be described.

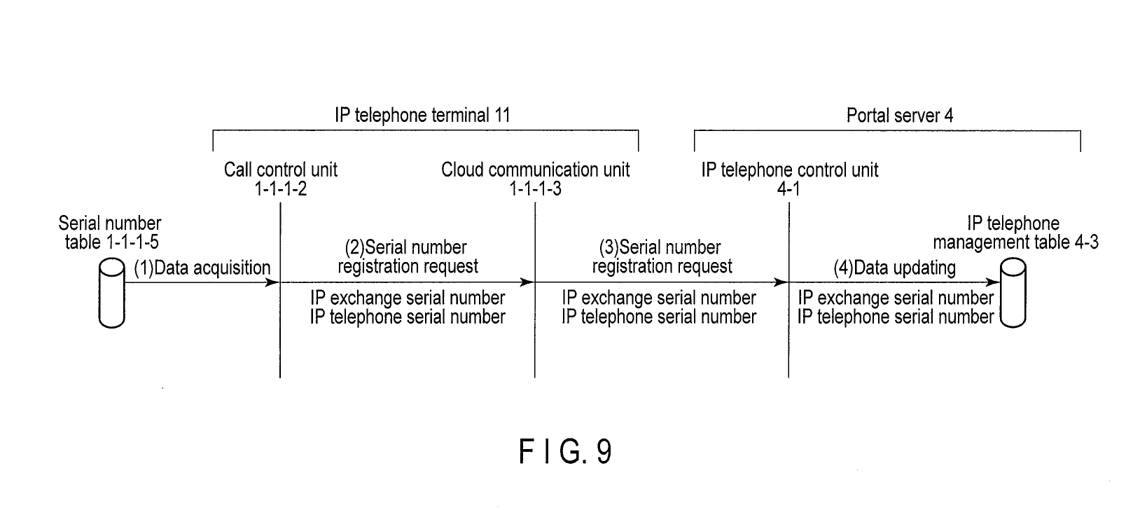

FIG. 9 shows an example of a sequence for registering a serial number in the cloud portal server 4 from the IP telephone terminal T11 when a user of the IP exchange 1-1 uses backup service provided by cloud computing.

The call control unit 1-1-1-2 of the IP telephone terminal T11 accommodated in the IP exchange 1-1 acquires serial number “12345678” of an accommodation destination IP exchange and serial number “abcd1234” of the IP telephone of the IP telephone terminal from the serial number table 1-1-1-5 (FIG. 9 (1)) and transmits a serial number registration request message to the cloud-based portal server 4 via the cloud communication unit 1-1-1-3 (FIGS. 9 (2) and (3)).

The cloud-based portal server 4 receives the serial number registration request message through the IP telephone control unit 4-1 and registers the IP exchange serial number and the IP telephone serial number, which are set in the message, in the IP telephone management table 4-3 (FIG. 9 (4)).

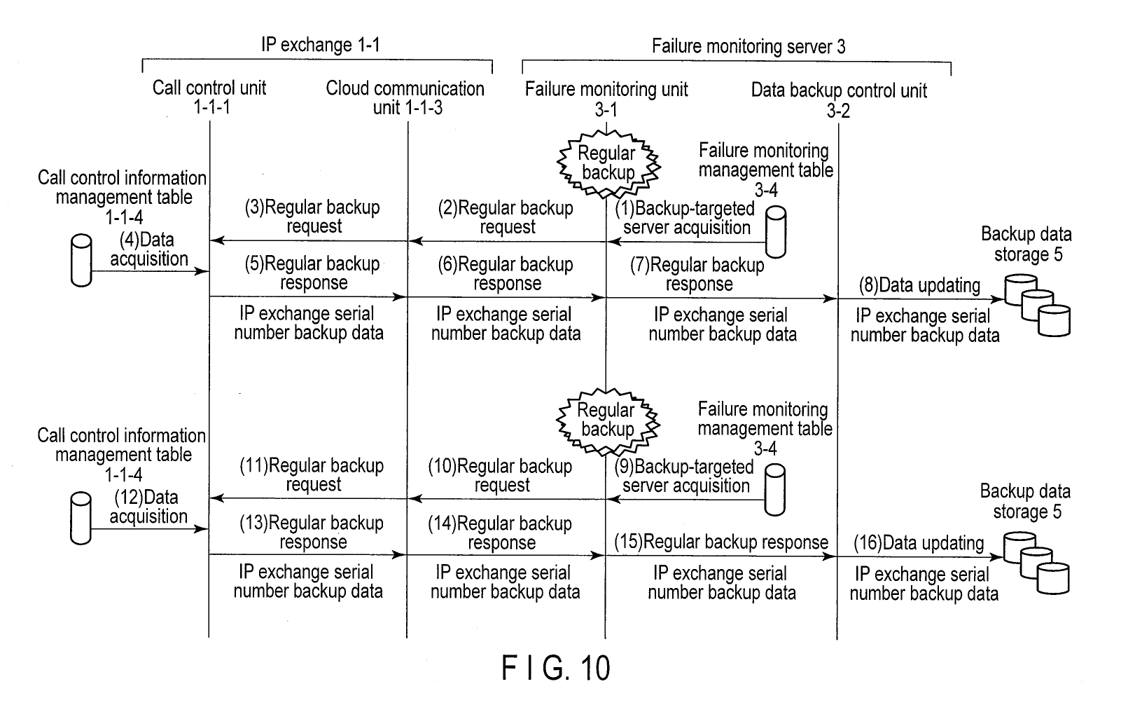

FIG. 10 shows an example of a sequence for regularly backing up call control information data of the IP exchange 1-1 from the cloud-based failure monitoring server 3 when the user of the IP exchange 1-1 uses the backup service provided by the cloud computing.

The cloud-based failure monitoring server 3 acquires a backup-targeted server from the failure monitoring management table 3-4 through the failure monitoring unit 3-1 at regular time intervals (FIG. 10 (1)) and transmits a regular backup request message to the corresponding IP exchange 1-1 (FIG. 10 (2)).

The IP exchange 1-1 receives the regular backup request message through the cloud communication unit 1-1-3 and then transmits a regular backup request message to the call control unit 1-1-1 (FIG. 10 (3)).

The call control unit 1-1-1 acquires backup data from the call control information management table 1-1-4 (FIG. 10 (4)), and sets the backup data and the IP exchange serial number and transmits a regular backup response message to the cloud-based failure monitoring server 3 via the cloud communication unit 1-1-3 (FIGS. 10 (5) and (6)).

Upon receiving the regular backup response message, the failure monitoring server 3 transmits a regular backup response message to the data backup control unit 3-2 (FIG. 10 (7)). Then, the data backup control unit 3-2 registers the IP exchange serial number and the backup data, which are set in the message, in the backup storage 5 (FIG. 10 (8)).

After a lapse of a fixed period of time, the cloud-based failure monitoring server 3 acquires a backup-targeted server from the failure monitoring management table 3-4 through the failure monitoring unit 3-1 (FIG. 10 (9)) and transmits a regular backup request message to the corresponding IP exchange 1-1 (FIG. 10 (10)).

Upon receiving the regular backup request message through the cloud communication unit 1-1-3, the IP exchange 1-1 transmits a regular backup request message to the call control unit 1-1-1 (FIG. 10 (11)).

The call control unit 1-1-1 acquires backup data from the call control information management table 1-1-4 (FIG. 10 (12)), and sets the backup data and the IP exchange serial number and transmits a regular backup response message to the cloud-based failure monitoring server 3 via the cloud communication unit 1-1-3 (FIGS. 10 (13) and (14)).

Upon receiving the regular backup response message, the failure monitoring server 3 transmits a regular backup response message to the data backup control unit 3-2 (FIG. 10 (15). Then, the data backup control unit 3-2 registers the IP exchange serial number and the backup data, which are set in the message, in the backup storage 5 (FIG. 10 (16)).

Here, there is a case where the registered content is updated from “unavailable” of “television conference function” to “available” of “television conference function,” for example.

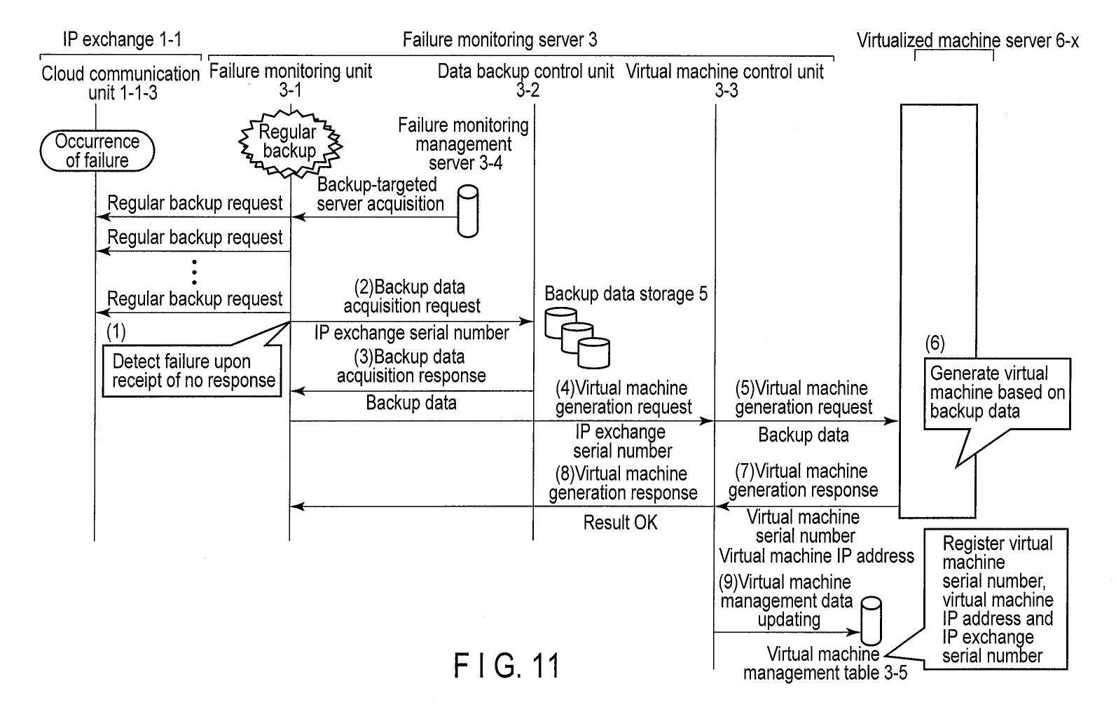

FIG. 11 shows an example of a sequence for detecting a failure of the backup-targeted IP exchange 1-1 by the cloud-based failure monitoring server 3.

In the regular backup process shown in FIG. 10, if the failure monitoring unit 3-1 cannot receive a response from the IP exchange 1-1 in a fixed period of time in response to a regular backup request from the failure monitoring server 3 (FIG. 11 (1)), it considers that the IP exchange 1-1 has failed and transmits a backup data acquisition request message in which the serial number of the IP exchange 1-1 is set, to the data backup control unit 3-2 (FIG. 11 (2)).

Upon receiving the backup data acquisition request message, the data backup control unit 3-2 acquires backup data of the IP exchange from the backup storage 5 using the serial number as a key and transmits a backup data acquisition response message to the failure monitoring unit 3-1 (FIG. 11 (3)).

Then, the failure monitoring unit 3-1 transmits a virtual machine generation request message in which the serial number and backup data of the IP exchange 1-1 are set, to the virtual machine control unit 3-3 (FIG. 11 (4)).

Upon receiving the virtual machine generation request message, the virtual machine control unit 3-3 confirms a usage state of a virtual machine (resource) set in the virtual machine management table 3-5 and transmits a virtual machine generation request message in which backup data is set, to the virtualized machine server 6-x capable of generating a virtual machine (FIG. 11 (5)).

Upon receiving the virtual machine generation request message, the virtualized machine server 6-x generates a virtual machine on the basis of the acquired backup data (FIG. 11 (6)) and returns a virtual machine generation response message in which the serial number and IP address of the generated virtual machine are set, to the failure monitoring server 3 (FIG. 11 (7)).

When the failure monitoring server 3 receives the above message, the virtual machine control unit 3-3 of the failure monitoring server 3 returns a virtual machine generation response message (result is OK) to the failure monitoring unit 3-1 (FIG. 11 (8)) and registers the virtual machine serial number and the virtual machine IP address in the virtual machine management table 3-5 in association with the serial number of the failed IP exchange (FIG. 11 (9)).

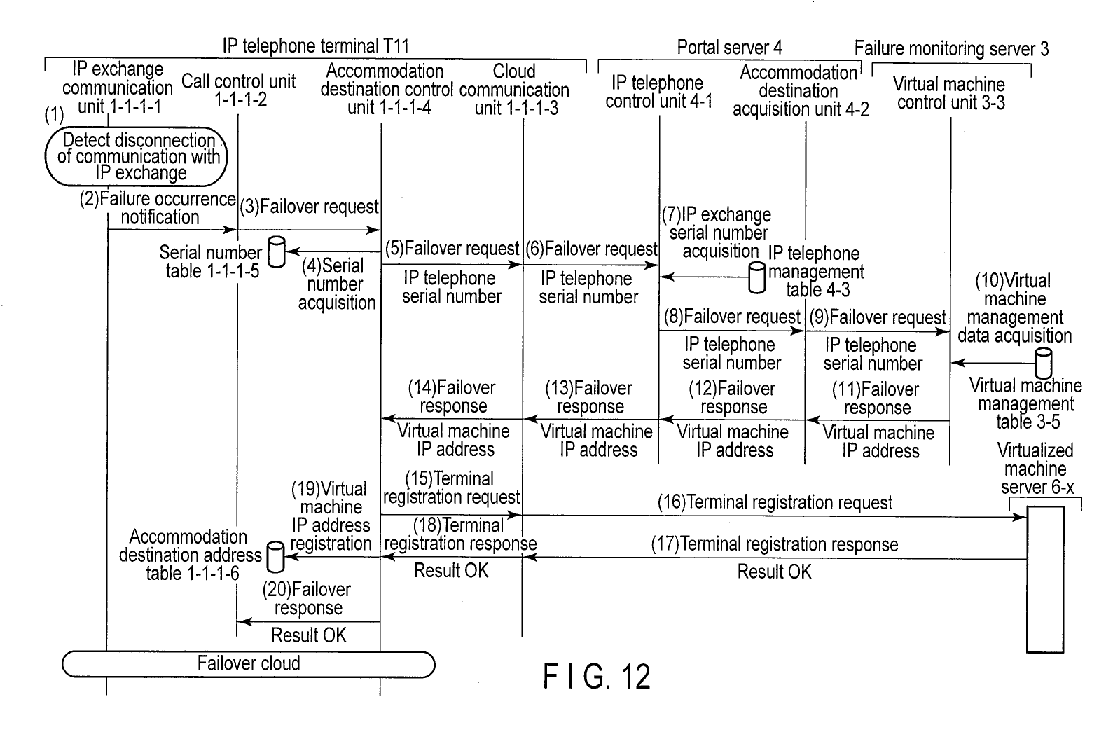

FIG. 12 shows an example of a sequence for failovering to the cloud computing by detecting a disconnection of communication between the IP telephone terminal T11 and the IP exchange 1-1 that has failed.

When the IP exchange communication unit 1-1-1-1 of the IP telephone terminal T11 detects a disconnection of communication with the IP exchange 1-1 (FIG. 12 (1)), it transmits a failure notification message to the call control unit 1-1-1-2 (FIG. 12 (2)).

Upon receiving the failure notification message, the call control unit 1-1-1-2 transmits a Failover request message to the accommodation destination control unit 1-1-1-4 (FIG. 12 (3)). Upon receiving the Failover request message, the accommodation destination control unit 1-1-1-4 acquires its own serial number from the serial number table 1-1-1-5 (FIG. 12 (4)), sets the serial number in the Failover request message and transmits it to the cloud-based portal server 4 through the cloud communication unit 1-1-1-3 (FIGS. 12 (5) and (6)).

When the portal server 4 receives the Failover request message, the IP telephone control unit 4-1 of the portal server 4 acquires the pre-registered IP exchange serial number from the IP telephone management table 4-3 using the IP telephone serial number as a key (FIG. 12 (7)) and transmits a Failover request message in which the serial number is set, to the accommodation destination acquisition unit 4-2 (FIG. 12 (8)).

Upon receiving the Failover request message, the accommodation destination acquisition unit 4-2 transmits a Failover request message to the failure monitoring server 3 (FIG. 12 (9)) and acquires a Failover destination virtual machine IP address from the virtual machine management table 3-5 via the virtual machine control unit 3-3 of the failure monitoring server 3 (FIGS. 12 (10) and (11)).

Furthermore, the accommodation destination acquisition unit 4-2 sets the Failover destination virtual machine IP address in a Failover response message and transmits it to the IP telephone terminal T11 via the IP telephone control unit 4-1 (FIGS. 12 (12) and (13)).

The IP telephone terminal T11 receives a signal from the portal server 4 via the cloud communication unit 1-1-1-3 (FIG. 12 (14)), transmits a terminal registration request to the virtual machine IP address set in the Failover response message via the cloud communication unit 1-1-1-3 (FIGS. 12 (15) and (16)), and normally completes registering a terminal in a virtual machine (CP container) having the IP address (FIGS. 12 (17) and (18)). Thus, the accommodation destination control unit 1-1-1-4 registers virtual machine IP address in the accommodation destination address table 1-1-1-6 (FIG. 12 (19)) and returns a Failover response to the call control unit 1-1-1-2, thus completing failovering to the cloud computing (FIG. 12 (20)).

Therefore, the user of the IP telephone terminal T11 is able to make a call and receive a call via the virtualized machine server 6-x and communicate with the user of the IP telephone terminal T15, for example.

As described above, according to the first embodiment, even though the IP exchange 1-1 serving as an accommodation destination of the IP telephone terminal T11 has failed, the accommodation destination of the IP telephone terminal T11 is automatically changed to a virtual machine (CP container) of a vacant virtualized machine server 6-x in accordance with the state of the virtualized machine servers 6-1 to 6-x (resources) of the cloud-based data center 2-1. Accordingly, voice communications can be continued without preparing a secondary exchange for each of the user sites US1 to USm.

### Second Embodiment

In the second embodiment, when it is detected that a failed IP exchange has recovered, the accommodation destination of an IP telephone terminal is changed from a cloud-based virtualized machine server to the original IP exchange.

In the second embodiment, a cloud-based failure monitoring server includes a virtual machine control unit 3-3 having a failure recovery control function. The failure recovery control function is a function in which if the accommodation destination of an IP telephone terminal T11 is changed to a virtualized machine server 6-x and then it is detected that a failure of an IP exchange 1-1 which is the original accommodation has been recovered, the accommodation destination of the IP telephone terminal T11 is returned to the IP exchange 1-1 under a predetermined condition.

Next, an operation of the second embodiment with the above configuration will be described.

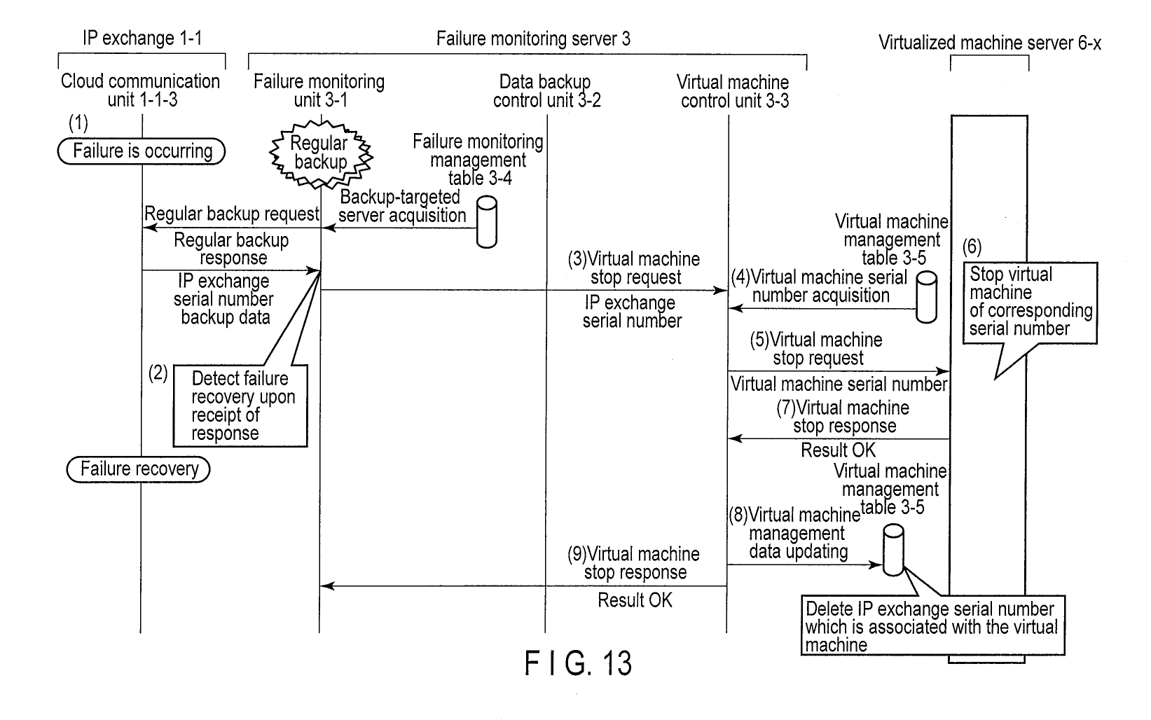

FIG. 13 shows an example of a sequence for detecting a recovery in failure of the backup-targeted IP exchange 1-1 by the cloud-based failure monitoring server 3.

While the IP exchange 1-1 is failing (FIG. 13 (1)), if a response can be received from the IP exchange 1-1 in response to a regular backup request in the regular backup process as shown in FIG. 10 (FIG. 13 (2)), it is considered that the failure of the IP exchange 1-1 has been recovered and thus a virtual machine stop request message in which the serial number of the IP exchange 1-1 is set is transmitted to the virtual machine control unit 3-3 (FIG. 13 (3)).

Upon receiving the virtual machine stop request message, the virtual machine control unit 3-3 acquires a serial number of a virtual machine assigned for backing up the IP exchange 1-1 from a virtual machine management table 3-5 using the IP exchange serial number as a key (FIG. 13 (4)), and transmits a virtual machine stop request message in which the virtual machine serial number is set to a corresponding virtualized machine server 6-x (FIG. 13 (5)).

Upon receiving the virtual machine stop request message, the virtualized machine server 6-x stops a corresponding virtual machine (CP container) using the virtual machine serial number as a key (FIG. 13 (6)) and returns a virtual machine stop response message to the failure monitoring server 3 (FIG. 13 (7)).

Furthermore, the virtual machine control unit 3-3 of the failure monitoring server 3 that has received the virtual machine stop response message deletes the IP exchange serial number, which is associated with the serial number of the stopped virtual machine (CP container), from the virtual machine management table 3-5 (FIG. 13 (8)) and returns a virtual machine stop response message to a failure monitoring unit 3-1 (FIG. 13 (9)).

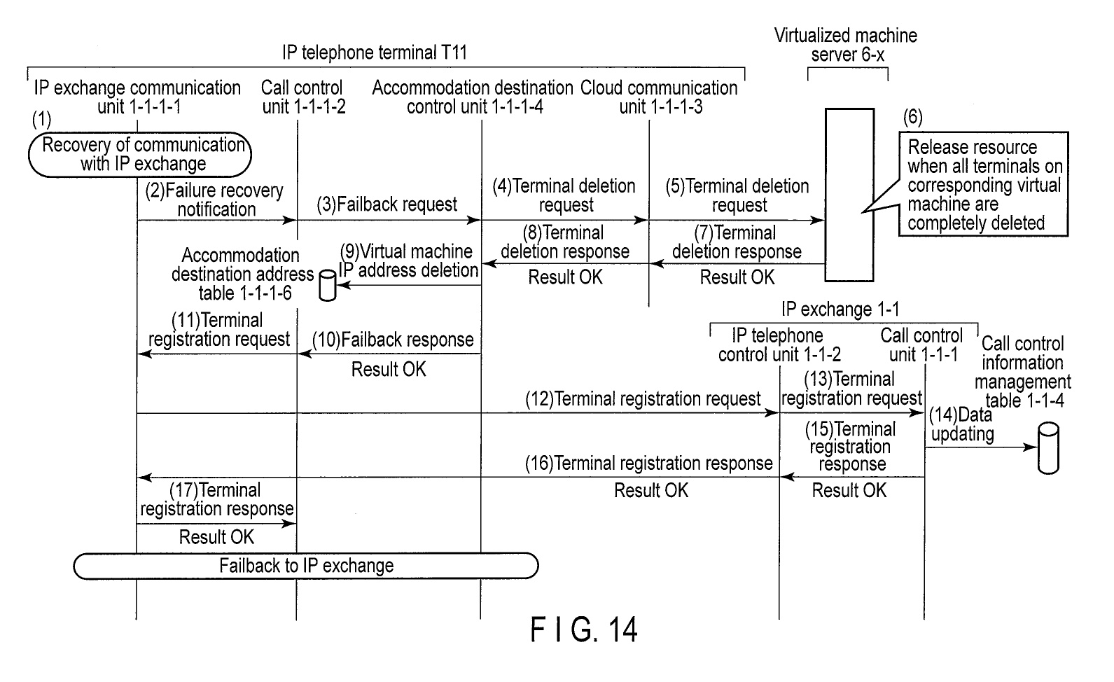

FIG. 14 shows an example of a sequence for failbacking to the IP telephone terminal T11 in a disconnect state of communication with the IP exchange 1-1 from cloud computing to the IP exchange 1-1 by detecting a recovery in failure of communication with the IP exchange 1-1.

When an IP exchange communication unit 1-1-1-1 of the IP telephone terminal T11 detects a recovery of communication with the IP exchange 1-1 (FIG. 14 (1)), it transmits a failure recovery notification message to a call control unit 1-1-1-2 (FIG. 14 (2)).

Upon receiving the failure recovery notification message, the call control unit 1-1-1-2 transmits a Failback request message to an accommodation destination control unit 1-1-1-4 (FIG. 14 (3)). Upon receiving the Failback request message, the accommodation destination control unit 1-1-1-4 transmits a terminal deletion request message to a Failover destination virtual machine via a cloud communication unit 1-1-1-3 (FIGS. 14 (4) and (5)).

Upon receiving the terminal deletion request message, the virtual machine (CP container) deletes a corresponding terminal (FIG. 14 (6)) and returns a terminal deletion response message to the IP telephone terminal T11 (FIG. 14 (7)). When the virtual machine deletes all the terminals, it releases an IP exchange backup resource.

Upon receiving the terminal deletion response message, the IP telephone terminal T11 transmits the terminal deletion response message to the accommodation destination control unit 1-1-1-4 (FIG. 14 (8)), deletes a virtual machine IP address from an accommodation destination address table 1-1-1-6 (FIG. 14 (9)) and returns a Failback response message to the call control unit 1-1-1-2 (FIG. 14 (10)).

Upon receiving the Failback response message, the call control unit 1-1-1-2 considers that the terminal registered in the cloud computing has been deleted and registers a terminal in the IP exchange 1-1 via the IP exchange communication unit 1-1-1-1 in a normal manner (FIGS. 14 (11), (12) and (13)).

When the IP exchange 1-1 receives a terminal registration request message, it registers the IP telephone terminal T11 in a call control information management table 1-1-4 (FIG. 14 (14)) and returns a terminal registration response message to the IP telephone terminal T11 (FIGS. 14 (15) and (16)).

Upon receiving the terminal registration response message from the IP exchange 1-1, the IP telephone terminal T11 transmits a terminal registration response message to the call control unit 1-1-1-2 (FIG. 14 (17)), thus completing failbacking to the IP exchange 1-1.

The above-described second embodiment is directed to a case where a virtual machine (CP container) is stopped as soon as a recovery of the failed IP exchange 1-1 is detected. However, when an IP exchange is frequently used like the IP exchange 1-2, a maintenance person is able to perform a process of returning an accommodation destination in a preset time zone such as midnight.

While the IP exchange 1-2 is failing, if a response can be received from the IP exchange 1-2 in response to a regular backup request from the failure monitoring server 3 in the regular backup process, it stands by until midnight. At midnight, it is considered that a failure of the IP exchange 1-2 is recovered, and a virtual machine stop request message in which the serial number of the IP exchange 1-2 is set, is transmitted to the virtual machine control unit 3-3.

Upon receiving the virtual machine stop request message, the virtual machine control unit 3-3 acquires the serial number of a virtual machine assigned for backup of the IP exchange 1-2 from the virtual machine management table 3-5 using the IP exchange serial number as a key, and transmits a virtual machine stop request message in which the virtual machine serial number is set, to the corresponding virtualized machine server 6-x.

Upon receiving the virtual machine stop request message, the virtualized machine server 6-x stops the corresponding virtual machine (CP container) using the virtual machine serial number as a key and returns a virtual machine stop response message to the failure monitoring server 3.

When the failure monitoring server 3 receives the virtual machine stop response message, the virtual machine control unit 3-3 of the failure monitoring server 3 deletes from the virtual machine management table 3-5 an IP exchange serial number associated with the serial number of the stopped virtual machine (CP container) and returns a virtual machine stop response message to the failure monitoring unit 3-1.

As described above, according to the second embodiment, when a failure of the IP exchange 1-1 that is the original accommodation is recovered, the accommodation destination of the IP telephone terminal T11 is automatically returned from the cloud-based virtualized machine server 6-x to the IP exchange 1-1. Accordingly, the accommodation of the IP telephone terminal T11 into the IP exchange 1-1 can be recovered without waiting for a maintenance person's recovery operation.

Furthermore, according to the second embodiment, the accommodation destination of the IP telephone terminal T11 is changed to the IP exchange 1-1 as soon as the failure of the IP exchange 1-1 is recovered and the accommodation destination of the IP telephone terminal T21 is changed to the IP exchange 1-2 whose failure is recovered in a time zone preset by a maintenance person, namely, at midnight. In other words, an appropriate recovery process can be performed for each user of the IP telephone terminal.

### Another Embodiment

In the above embodiments, when an IP exchange to be monitored fails on the cloud computing side, an empty resource is searched for and a virtual machine for backup of the IP exchange is generated on the cloud computing. However, when a user of the IP exchange determines the use of a backup service provided by the cloud computing, a backup virtual machine can be generated in advance on the cloud computing and occupied at all times. Moreover, when a plurality of IP exchanges fail within a given period of time, the Failover process can be performed for the IP exchanges in descending order of priority by setting a fixed time period for determining a failure of an IP exchange to be monitored and also setting priority for the IP exchanges. Similarly, when a plurality of failed IP exchanges are recovered within a given period of time, a Failback process can be performed for the IP exchanges in descending order of priority.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of changing a terminal accommodation destination, which is used in a server apparatus including a plurality of resources and connected to a plurality of exchanges via a communication network, the plurality of exchanges performing an exchange service associated with a call connection among a plurality of communication terminals, the method comprising:
detecting a failure of at least one of the plurality of exchanges; and
when a failed exchange is detected, changing an accommodation destination of a communication terminal accommodated in the failed exchange to the server apparatus in accordance with a usage state of the plurality of resources.

2. The method of claim 1, wherein:
the detecting includes monitoring a failure state of each of the plurality of exchanges regularly by the server apparatus; and
the changing includes, when a failed exchange is detected, acquiring an empty one of the plurality of resources and changing an accommodation destination of a communication terminal accommodated in the failed exchange to the server apparatus.

3. The method of claim 2, wherein the detecting includes supplying a signal periodically to each of the plurality of exchanges from the server apparatus, returning a response signal, and determining that an exchange has failed when no response signal is returned.

4. The method of claim 1, further comprising returning the accommodation destination of the communication terminal to the at least one of the plurality of exchanges under a predetermined condition if the accommodation destination of the communication terminal is changed to the server apparatus and then a recovery of the failure of the at least one of the plurality of exchanges, which is an original accommodation, is detected.

5. The method of claim 4, wherein as the predetermined condition, the returning promptly changes the accommodation destination to an exchange whose failure is recovered and uses at least one time zone preset by a maintenance person.

6. A server apparatus including a plurality of resources and connected to a plurality of exchanges via a communication network, the plurality of exchanges performing an exchange service associated with a call connection among a plurality of communication terminals, the server apparatus comprising:
a detecting unit configured to detect a failure of at least one of the plurality of exchanges; and
a change control unit configured to, when a failed exchange is detected, change an accommodation destination of a communication terminal accommodated in the failed exchange to the server apparatus in accordance with a usage state of the plurality of resources.

7. The server apparatus of claim 6, wherein:
the detecting unit monitors a failure state of each of the plurality of exchanges regularly; and
when the detecting unit detects a failed exchange, the change control unit acquires an empty one of the plurality of resources and changes an accommodation destination of a communication terminal accommodated in the failed exchange to the server apparatus.

8. The server apparatus of claim 7, wherein the detecting unit periodically supplies a signal to each of the plurality of exchanges, returns a response signal, and determines that an exchange has failed when no response signal is returned.

9. The server apparatus of claim 6, further comprising a recovery control unit configured to return the accommodation destination of the communication terminal to the at least one of the plurality of exchanges under a predetermined condition if the accommodation destination of the communication terminal is changed to the server apparatus and then a recovery of the failure of the at least one of the plurality of exchanges, which is an original accommodation, is detected.

10. The server apparatus of claim 9, wherein as the predetermined condition, the recovery control unit promptly changes the accommodation destination to an exchange whose failure is recovered and uses at least one time zone preset by a maintenance person.

11. A terminal apparatus accommodated in an exchange and connected to a server apparatus including a plurality of resources via a communication network, the terminal apparatus comprising:
a detecting unit configured to detect a failure of an exchange of an original accommodation; and
a change control unit configured to, when a failed exchange is detected, change an accommodation destination to the server apparatus in accordance with a usage state of the plurality of resources of the server apparatus.

12. The terminal apparatus of claim 11, further comprising a recovery control unit configured to return the accommodation destination to the exchange if the accommodation destination is changed to the server apparatus and then a recovery of the failure of the exchange, which is an original accommodation, is detected by the server apparatus.
